(19) United States
(12) Patent Application Publication
(10) Pub. No.: US 2003/0053317 A1
(43) Pub. Date: Mar. 20, 2003

(54) Raised brake light assembly for vehicles, especially motor vehicles

(75) Inventor: Jens Mertens, Stuttgart (DE)

Correspondence Address: GUDRUN E. HUCKETT, LONSSTR. 53, WUPPERTAL, 42289, DE

(73) Assignee: Schefenacker Vision Systems Germany GmbH & Co. KG, Esslingen (DE)

(21) Appl. No.: 10/065,064

(22) Filed: Sep. 13, 2002

(30) Foreign Application Priority Data
Sep. 15, 2001 (DE) 101 45 528.3

(51) Int. Cl. B60Q 1/00

(52) U.S. Cl. 362/487

(57) ABSTRACT

A raised brake light assembly for motor vehicles has a housing and a housing lens closing off the housing. At least one brake light is arranged in the housing behind the housing lens. At least one ambient light assembly is arranged within the housing. The at least one ambient light assembly radiates light in a direction different from the direction in which the at least one brake light radiates.

### BACKGROUND OF THE INVENTION

1. Field of the Invention

The invention relates to a raised brake light assembly for vehicles, especially motor vehicles, comprising a housing in which at least one brake light is arranged behind a lens.

2. Description of the Related Art

Raised brake light assemblies are known which are fastened to the hatchback door of a motor vehicle. Moreover, it is known to provide motor vehicles with ambient light assemblies for illuminating the surroundings, for example, for illuminating the trunk space or luggage compartment of a motor vehicle or the ground adjacent to or behind the motor vehicle. The different light assemblies are mounted separately and are connected to the electrical onboard system of the motor vehicle. For this purpose, electrical connectors, plugs and cable sets are required for each light assembly.

### SUMMARY OF INVENTION

It is an object of the present invention to configure the raised brake light assembly such that it can be manufactured and mounted inexpensively while having a constructively simple configuration.

In accordance with the present invention, this is achieved in that in the housing of the brake light assembly at least one ambient light assembly is arranged which emits light in a different direction than the brake light.

The brake light assembly according to the invention not only comprises the brake light itself but also the ambient light assembly. As a result of the integration of the ambient light assembly into the raised brake light assembly it is only required to provide electrical connectors, plugs, and cable sets for a single module. In this way, mounting of the brake light assembly according to the invention is significantly simplified. Mounting and manufacturing costs can be reduced. The brake light assembly not only functions as a signaling light for the traffic participants following the vehicle but also as a means for illuminating the surroundings of the motor vehicle as needed, for example, the interior of the motor vehicle or the luggage compartment or the trunk space. In particular, it is possible to illuminate by means of the ambient light assembly the ground directly behind the motor vehicle when the hatchback door of the motor vehicle is opened.

### DESCRIPTION OF DRAWINGS

FIG. 1 is a rear view of a brake light assembly according to the invention.

FIG. 2 is a plan view onto the brake light assembly according to FIG. 1.

FIG. 3 shows the brake light assembly according to FIGS. 1 and 2 in a first perspective view.

FIG. 4 shows the brake light assembly according to FIGS. 1 and 2 in a second perspective view.

FIG. 5 shows a brake light assembly according to the invention in an enlarged illustration without the housing.

FIG. 6 shows the brake light assembly without housing in a perspective illustration.

FIG. 7 is a schematic illustration of a cross-section of the brake light assembly according to FIGS. 1 to 6 in the mounted position.

FIG. 8 shows in an illustration corresponding to FIG. 7 a second embodiment of the brake light assembly according to the invention.

FIG. 9 is a schematic illustration of the brake light assembly according to the invention mounted on the hatchback door of a motor vehicle in a closed and open position of the hatchback.

### DETAILED DESCRIPTION

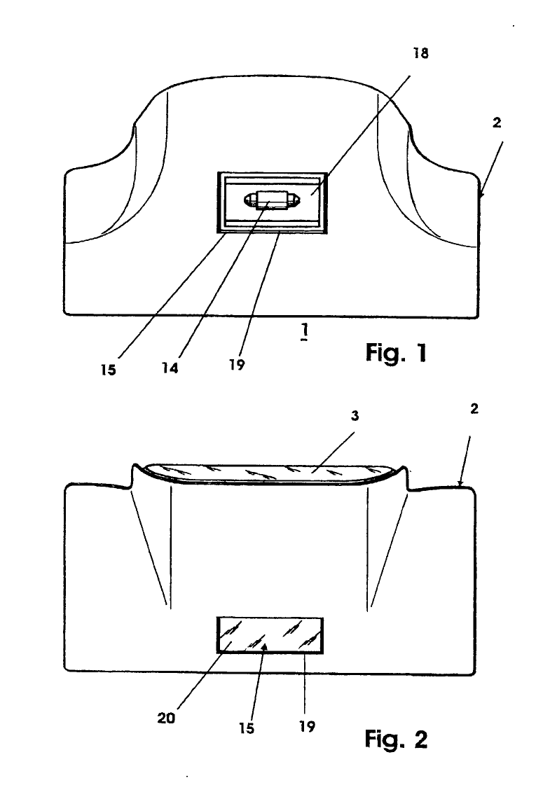

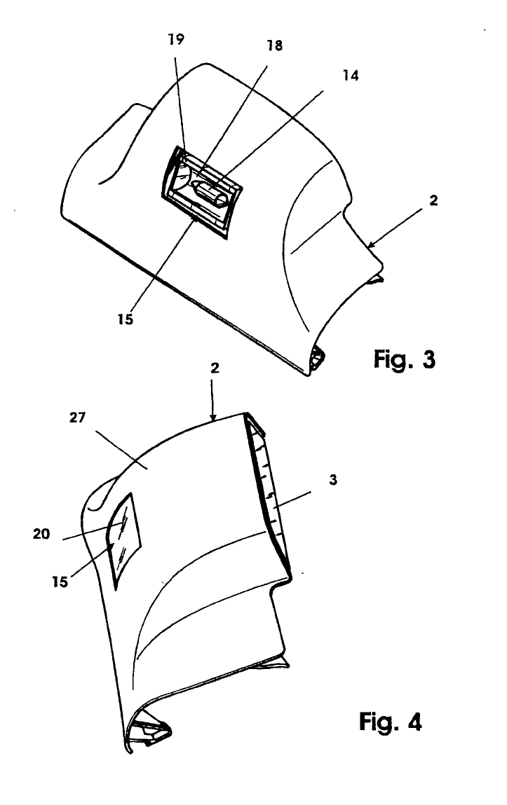

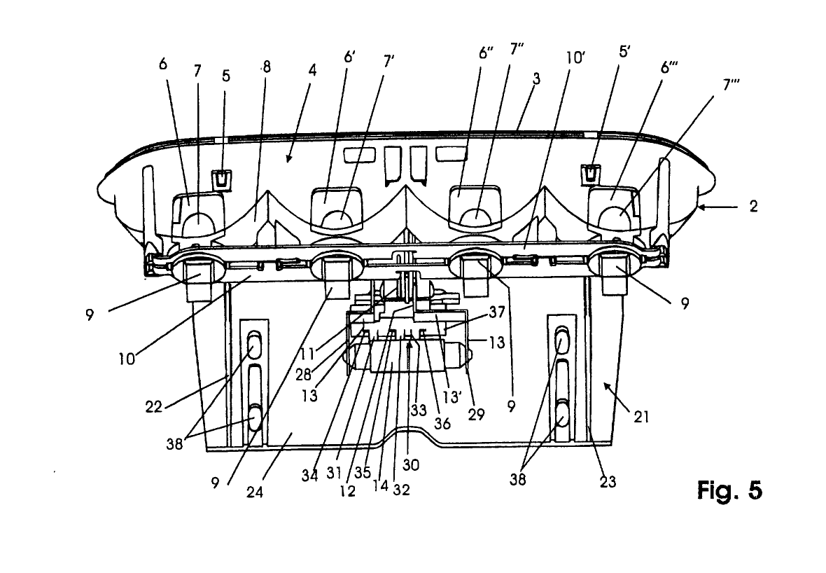

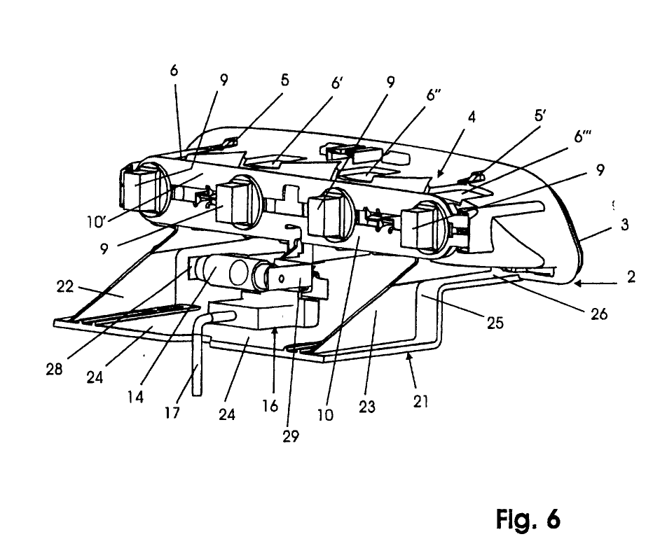

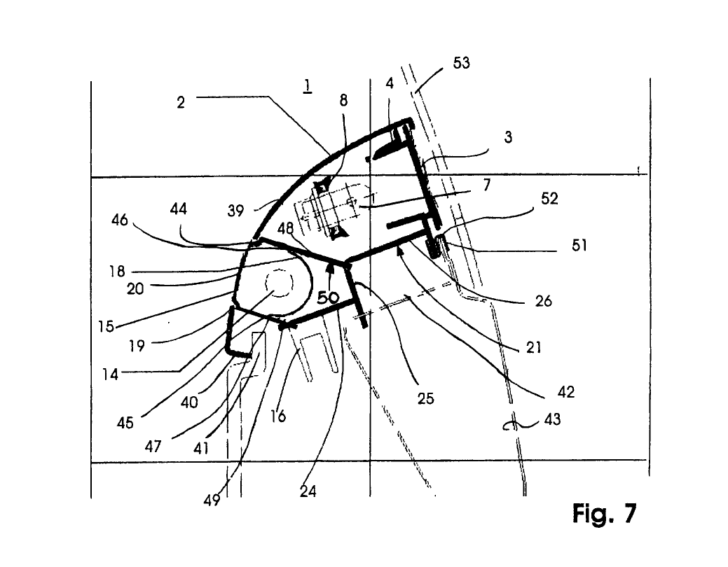

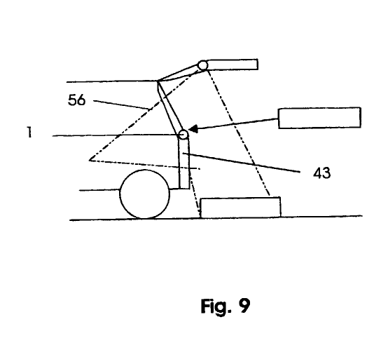

The raised brake light assembly 1 illustrated in FIGS. 1 through 7 is provided for motor vehicles having a hatchback (FIGS. 7 and 9). It is arranged behind the rear window 53 on the hatchback door 43 of the motor vehicle at the level of the lower window edge or the upper edge of the hatchback door 43. The brake light assembly 1 has a housing 2 with an opening which is covered by a housing lens 3. The housing lens 3 may be tinted red. However, it is also possible to provide a transparent or clear lens behind which a color filter is arranged which ensures that red light can be emitted to the rear through the clear lens. It is also possible to provide a light source in the form of LEDs emitting red light. The housing 2 receives a reflector housing 4 on which the housing lens 3 is secured, for example, by means of snap-on members 5, 5′. The reflector housing 4 and the housing lens 3 form a closed housing into which the light sources 7, 7′ through 7′″ project. These light sources may be incandescent light bulbs or LEDs. In the embodiment described in the following, the light sources are in the form of incandescent light bulbs; however, it is possible, of course, to use light sources such as LEDs in their place. The reflector housing 4 is provided with venting openings 6, 6′ through 6′″ at the level of the incandescent lamps 7, 7′ to 7′″ through which the heat resulting from operation of the brake light assembly is dissipated. The incandescent light bulbs 7, 7′ through 7′″ are positioned in front of a reflector surface 8 of the reflector housing 4 (FIG. 5), respectively, which deflects the light emitted by the incandescent lamps 7, 7′ to 7′″ forwardly to the housing lens 3. The incandescent lamps 7, 7′ through 7′″ are mounted on a lamp support 9 (FIGS. 5 and 6) which, opposite to the housing lens 3, projects to the rear through corresponding openings in the reflector housing 4. The lamp supports or lamp sockets are fastened on the reflector housing 4, as is known in the art.

All of the incandescent lamps 7, 7′ through 7′″ have an electrical supply line 10 which is formed by a sheet metal strip and extends transversely to the axis of the lamp supports 9. In the illustrated embodiment, this supply line 10 is positioned external to the reflector housing 4 parallel to the housing lens 3.

The lamp supports 9 are provided with a ground contact 10′ parallel to the flat sheet metal strips 10 which enable the current supply to the incandescent lamps 7, 7′ through 7′″. The ground contact 10′ is also strip-shaped and comprised of sheet metal and is positioned at a minimal spacing adjacent to the supply line 10. As illustrated in FIGS. 5 and 6, the supply line 10 and the ground contact 10′ are parallel to one another. The ground contact 10′ is also positioned external to the reflector housing 4 on a side facing away from the housing lens 3.

The reflector housing 4 is seated on at least one support 21 which is formed as a unitary part of the reflector housing 4. However, it is also possible to fasten the reflector housing 4 as a separate component on the carrier 21. As illustrated in FIG. 6, the carrier 21 is Z-shaped and extends across the greater part of the length of the reflector housing 4. For reinforcing the carrier 21, supports 22, 23 are provided in the vicinity of its two ends which extend perpendicularly to the carrier 21 and are approximately triangular in a side view. The supports 22, 23 are positioned perpendicularly to the leg 24 of the carrier 21 and extend to an intermediate stay 25 which is positioned perpendicularly to the leg 24 and connects it to a further leg 26 on which the reflector housing is arranged. The supports 22, 23 extend perpendicularly to the leg 24 and to the intermediate stay 25 and taper in a direction to the free end of the leg 24. The carrier 21 is advantageously of a unitary configuration. Its legs 24, 26, positioned at different levels, as well as the intermediate stay 25 are planar, respectively.

In the area between the two lateral supports 22, 23 of the carrier 21 a reflector 18 (FIG. 1) is provided which surrounds an additional light source 14 which can be an incandescent lamp or LED. The reflector 18 is positioned behind the housing opening 19 which is provided in a back wall 27 of the housing 2. The housing opening 19 is closed by a lens 20 (FIGS. 2 and 4). This lens 20 can be clear or tinted. As can be taken from FIGS. 2 and 4, the rays which are emitted by the light sources 14 exit in a different direction from the housing 2 to the exterior than the rays which are emitted by the light sources 7, 7′ through 7′″ through the housing lens 3. The housing opening 19 has in the illustrated embodiment a rectangular contour and is significantly smaller than the opening of the housing 2 which is covered by the housing lens 3. In the illustrated embodiment the entire side of the housing 2 oriented to the rear of the motor vehicle is formed by a housing lens 3.

Instead of the single housing opening 19 being provided in the housing 2, additional openings can be provided in which a light source is arranged, respectively. The light source 14 with the reflector 18 and the lens 20 provides an ambient light assembly 15 which is separated optically from the incandescent lamps 7, 7′ through 7′″ in the reflector housing 4.

The reflector 18 can be fastened easily and reliably on the carrier 21.

The light source 14 is secured between a contact sheet metal 28 and a ground contact 29. It is formed of a sheet metal strip which is bent out of the ground contact sheet metal 10′ for the incandescent lamps 7, 7′ through 7′″.

As shown in FIG. 5, a common plug connector 30 is provided for the incandescent lamps 7, 7′ through 7′″ and the light source 14 which plug connector 30 has a three-pole configuration. It has three contact tongues 31 through 33 to which a single three-pole plug 16 (FIG. 6) is connected which is provided with an electrical supply line 17. The contact tongue 31 is correlated with the contact sheet metal 28, the contact tongue 32 with the contact sheet metal 10, and the contact tongue 33 with the ground contacts 10′, 29. Accordingly, when the plug 16 is connected to the connector 30, the incandescent lamps 7, 7′ to 7′″ as well as the light source 14 are supplied with the required current.

The contact sheet metal 28 is Z-shaped and arranged on edge relative to the ground contact sheet metal 10 of the incandescent lamps 7, 7′ to 7′″.

The contact tongue 32 and the contact tongue 10 together are of a unitary configuration; the contact tongue 32 is formed as a stay 11 which extends perpendicularly to the contact sheet metal 10.

The ground contact 29 is also Z-shaped and formed by a stay 12 bent out of the ground sheet metal 10′. The contact tongue 32 is bent out of this stay 12. As illustrated in FIG. 5, the contact sheet metal 28 and the ground contact 29 are arranged approximately mirror-symmetrically to one another wherein the central stays 13, 13′ are advantageously positioned in a common plane which is positioned in the illustrated embodiment parallel to the plane in which the two contacts 10, 10′ are arranged. The contact tongue 33 is bent out of the ground contact 29.

All of the contact tongues 31 through 33 are positioned in the illustrated embodiment in a common plane and project through slots 34 to 36 which are provided in a holder 37 provided on the carrier 21. It is advantageously formed as a unitary part of the carrier 21 and arranged on the intermediate stay 25 of the carrier 21. The holder 37 projects transversely from the intermediate stay 25 so that the plug 16 can be simply connected thereto.

The plug 16 is connected to a current/voltage source of the motor vehicle. By means of the single plug 16 the incandescent lamps 7, 7′ to 7′″ as well as the light source 14 are supplied with the required current.

When the hatchback door 43 of the motor vehicle is closed, the housing lens 3 is oriented to the rear in the travel direction so that, when a braking operation occurs, the traffic participants following the vehicle are warned in a timely fashion that the driver is braking. The ambient light assembly 15 is oriented toward the interior of the motor vehicle and can illuminate a large surface area of the interior. The ambient light assembly 15 is switched on by a hatchback door contact upon opening the hatchback door or by a separate switch which is provided directly on the brake light assembly 1. Advantageously, a corresponding switch is arranged in an area accessible to the driver so that, if needed, the driver can switch on or off the ambient light assembly at any time. When the hatchback door 43 of the motor vehicle opened, the ambient light assembly 15 will illuminate the ground surface directly behind the vehicle as well as a luggage compartment (FIG. 9).

Advantageously, the ambient light assembly 15 is switched on automatically when the hatchback door 43 of the motor vehicle is opened. In this case, the contact tongue 31 is part of a hatchback door contact (not illustrated). It is configured such that upon opening of the hatchback door it is actuated and in this way the current supply to the light source 14 of the ambient light assembly 15 is enabled. In reverse, this hatchback door contact 31 is closed again when the hatchback door 43 is closed.

The brake light assembly 1 can be attached on the motor vehicle by means of the carrier 21 in simple way at the desired mounting location. For this purpose, the leg 24 of the carrier 21 is provided with through openings 38 through which fastening screws can be inserted. The openings 38 are positioned adjacent to the supports 22, 23 on sides facing one another (FIG. 5).

The housing 2 is mounted when incandescent lamps 7, 7′ through 7′″ have been inserted into the sockets 9, the housing lens 3 has been fastened on the reflector housing 4, and the light source 14 is inserted into the ambient light assembly 15. In this state, the housing 2 which is formed as a cover can be slipped into position on a side facing away from the housing lens 3 and can be detachably mounted in a suitable way. In this way, all components of the brake light assembly 1 are reliably protected inside the cover against damage and/or soiling.

Instead of the described incandescent lamps 7, 7′ through 7′″; 14, it is possible to employ, for example, LEDs as light sources.

As illustrated in FIG. 7, the housing 2 has a top side 39 which in cross-section is curved and whose edge 40 facing away from the housing lens 3 is angled and rests against an edge 41 in the mounting area 42 of the hatchback door 43 of the motor vehicle.

The reflector 18 of the ambient light assembly 15 has a cross-section that is part circular and is inserted with angled longitudinal edges 44, 45 into receptacles 46, 47 in the side walls 48, 49 of a housing 50 of the ambient light assembly 15. The housing 50 itself is fastened on the carrier 21, preferably on the intermediate stay 25 and the leg 24. Advantageously, the housing 50 is detachably connected on the support 21 so that the ambient light assembly 15 can be removed easily. The exterior side of the lens 20 of the ambient light assembly 15 is positioned preferably flush with the outer side of the housing 2.

Since the ambient light assembly 15 is a separate component, it can be easily assembled and subsequently fastened as a single part on the carrier 21. Advantageously, the housing 50 of the ambient light assembly 15 is detachably fastened on the carrier 21 whose leg 24 and intermediate stay 25 closes the housing 50 on the side opposite the lens 20.

As illustrated in FIG. 7, the brake light assembly 1 can be fastened with fastening elements, preferably in the form of snap-on clamps 51, on an edge 52 of the hatchback door 43 behind the rear window 53.

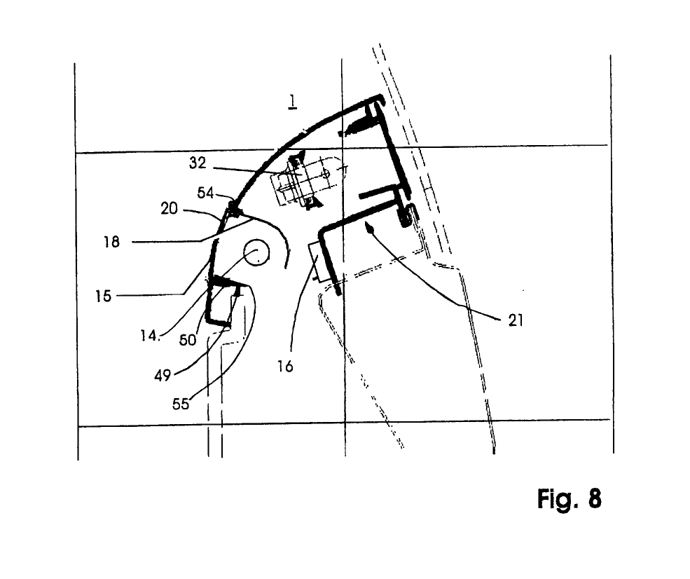

In the embodiment according to FIG. 8, the housing 50 of the ambient light assembly 15 is not closed but open at the side opposite the lens 20. The lens 20 is provided at its inner side with a snap-on receptacle 54 into which the reflector 18 is inserted with one edge. It surrounds the light source 14 of the ambient light assembly 15 partially and ends at a spacing from the free edge 55 of the sidewall 49 of the housing 50.

The carrier 21 is substantially L-shaped in cross-section. In contrast to the embodiment of FIGS. 1 through 7, the carrier 21 has no leg 24. In other respects, the embodiment of FIG. 8 is identical to the preceding embodiment. The ambient light assembly 15 is provided as a separate component which can be assembled quickly before mounting in the brake light assembly 1. It can be fastened subsequently without problems on the brake light assembly (taillight) 1.

FIG. 9 shows schematically the positions of the taillight 1 on the hatchback door 43 of the motor vehicle. Upon actuation of the brake pedal, the incandescent lamps 7, 7′ through 7′″ are illuminated and radiate in the travel direction to the rear through the rear window 53 of the hatchback door 43.

When the hatchback door 43 is opened, the ambient light assembly 15 is switched on by means of the hatchback door contact when pivoting the hatchback door 43 upwardly. The ambient light assembly 15 is arranged such in the brake light assembly 1 that the light 56, emitted by it and whose illumination area is indicated by a dash-dotted line, is partially sent into the interior of the vehicle as well as to the ground surface directly behind the motor vehicle. In this way, the ground surface behind the motor vehicle is illuminated; this is advantageous particularly at night. Since the hatchback door 43, when moved upwardly into the open position, allows the illumination of this ground area, it is possible, for example, to place pieces of luggage onto this illuminated ground surface without there being the risk that the luggage becomes soiled when placed on the ground.

While specific embodiments of the invention have been shown and described in detail to illustrate the inventive principles, it will be understood that the invention may be embodied otherwise without departing from such principles.

What is claimed is:

1. A raised brake light assembly for motor vehicles, comprising:
a first housing (2);
a housing lens (3) closing off the first housing (2);
at least one brake light (7, 7′, 7″,7′″) arranged in the first housing (2) behind the housing lens (3) and radiating light in a first direction;
at least one ambient light assembly (15) arranged within the first housing (2);
wherein the at least one ambient light assembly (15) radiates light in a second direction different from the first direction in which the at least one brake light (7, 7′, 7″,7′″) radiates.

2. The brake light assembly according to claim 1, wherein the at least one ambient light assembly (15) comprises at least one light source (14).

3. The brake light assembly according to claim 1, wherein the at least one ambient light assembly (15) comprises at least one of a lens (20) and a reflector (18).

4. The brake light assembly according to claim 3, wherein the at least one ambient light assembly (15) is a component connectable to a part of the brake light assembly (1).

5. The brake light assembly according to claim 1, wherein the at least one ambient light assembly (15) has a second housing (50) in which at least one of a light source (14) and a reflector (18) of the at least one ambient light assembly (15) is arranged.

6. The brake light assembly according to claim 5, wherein the second housing (50) is detachably fastened on the brake light assembly (1).

7. The brake light assembly according to claim 5, comprising a carrier (21) on which the second housing (50) of the ambient light assembly (15) is secured.

8. The brake light assembly according to claim 7, further comprising a reflector housing (4) secured on the carrier (21), wherein the at least one brake light (7,7′to 7′″) is arranged in the reflector housing (4).

9. The brake light assembly according to claim 8, wherein the first housing (2) is secured on the reflector housing (4).

10. The brake light assembly according to claim 7, wherein the at least one ambient light assembly (15) is secured in the first housing (2).

11. The brake light assembly according to claim 7, wherein the first housing (2) has at least one opening (19) allowing passage of rays (56) emitted by the at least one ambient light assembly (15).

12. The brake light assembly according to claim 7, wherein the carrier (21) is provided with fastening elements (51) configured to secure the carrier (21) on the motor vehicle.

13. The brake light assembly according to claim 12, wherein the fastening elements (51) are snap-on clamps.

14. The brake light assembly according to claim 1, configured to be arranged on a hatchback door (43) of a motor vehicle such that, when the hatchback door (43) is open, light (56) emitted by the at least one ambient light assembly (15) at least partially illuminates a ground surface behind the motor vehicle.

15. The brake light assembly according to claim 1, configured to be arranged on a hatchback door (43) of a motor vehicle such that, when the hatchback door (43) is open, at least a portion of the light (56) emitted by the at least one ambient light source (15) illuminates an interior of the vehicle.

16. The brake light assembly according to claim 15, wherein the light (56) emitted by the at least one ambient light source (15) illuminates a trunk space or a luggage compartment of the motor vehicle.

17. The brake light assembly according to claim 1, comprising a common ground contact (43) connected to the at least one brake light (7, 7′ to 7′″) and at least one light source (14) of the at least one ambient light assembly (15).

18. The brake light assembly according to claim 1, comprising a common plug connector connected to the at least one brake light (7,7′ to 7′″) and at least one light source (14) of the at least one ambient light assembly (15).

19. The brake light assembly according to claim 1, wherein the housing lens (3) and a lens (20) of the at least one ambient light assembly (15) are provided on opposite sides of the first housing (2).

20. The brake light assembly according to claim 19, wherein the lens (20) of the at least one ambient light assembly (15) is smaller than the housing lens (3).
